(19) United States
(12) Patent Application Publication
(10) Pub. No.: US 2012/0249472 A1
(43) Pub. Date: Oct. 4, 2012

(54) TOUCH SCREEN SYSTEM AND METHODS OF CALCULATING TOUCH POINT THEREOF

(76) Inventors: Won-ki HONG, Suwon-si (KR); Seungho Nam, Seongnam-si (KR); Jeehong Min, Seongnam-si (KR); Sugyeong Lee, Seongnam-si (KR)

(21) Appl. No.: 13/356,345

(22) Filed: Jan. 23, 2012

(30) Foreign Application Priority Data
Mar. 31, 2011 (KR) 10-2011-0029803

(51) Int. Cl. G06F 3/045

(52) U.S. Cl. 345/174

(57) ABSTRACT

Provided is a touch screen. The touch screen includes a touch panel including a first substrate and a second substrate that face each other. The first resistor line part is bent several times, has a first end receiving a first voltage, and has a second end receiving a second voltage having a potential lower than the first voltage. Also, the touch screen includes a touch detection unit that determine whether a touch event occurs, a single/multi touch determination unit that determines whether the touch event is single touch or multi-touch, and a coordinate information calculating unit that calculates coordinate information of a touched point. Therefore, the touch screen may calculate coordinate information of multi-touched points.

### CROSS-REFERENCE TO RELATED APPLICATIONS

This U.S. non-provisional patent application claims priority under 35 U.S.C. §119 of Korean Patent Application No. 10-2011-0029803, filed on Mar. 31, 2011, the entire contents of which are hereby incorporated by reference.

### BACKGROUND

The present disclosure herein relates to a touch screen system and a method of calculating a touch point thereof, and more particularly, to a touch screen system and a method of calculating a touch point thereof, which determine single touch and multi-touch.

Information display devices such as portable phones, Personal Digital Assistants (PDAs), and navigation devices are being given the added function of multimedia providing means. Typical information display devices use a keypad as input means. Recently, information display devices have been miniaturized and use a touch screen as input means to provide a large display screen. A touch screen is attached to a display panel of an information display device and used.

Touch screens are generally categorized into resistive touch screens and capacitive touch screens. Resistive touch screens are categorized into analog resistive touch screens and digital resistive touch screens.

In determining multi-touch, analog resistive touch screens are more limited than capacitive touch screens. Also, while digital resistive touch screens are capable of determining multi-touch, they are difficult to manufacture because they require a plurality of resistor patterns.

### SUMMARY

The present disclosure provides a touch screen which can determine multi-touch and can be miniaturized.

The present disclosure also provides a method of calculating a touch point on the touch screen.

Embodiments of the inventive concept provide a touch screen including: a touch panel including a first substrate, a second substrate facing the first substrate, a first resistor line part, and a second resistor part provided on one surface of the second substrate to face the first resistor line part, wherein the first resistor line part is bent several times, provided on one surface of the first substrate, has a first end receiving a first voltage, and has a second end receiving a second voltage having a potential lower than the first voltage; a touch detection unit configured to detect a voltage outputted from the second resistor part to determine whether a touch event occurs, when the first resistor line part and the second resistor part contact each other by an external pressure or force; a single/multi touch determination unit configured to determine the touch event as single or multi touch by measuring a current in the first resistor line part and comparing a level of the measured current with a level of a predetermined reference current, when the touch event is determined as occurring, wherein the single/multi touch determination unit determines the touch event as single touch when the level of the measured current is lower than or equal to the level of the predetermined reference current, or determines the touch event as multi-touch when the level of the measured current is higher than the level of the predetermined reference current; and a coordinate information calculating unit configured to calculate and output coordinate information of a single-touched first point or one of coordinate information of multi-touched second and third points.

In other embodiments of the inventive concept, a method of calculating a touch point of a touch screen includes: applying a first voltage to a first end of the first resistor line part, and applying a second voltage having a potential lower than the first voltage to a second end of the first resistor line part; detecting a voltage outputted from the second resistor part to determine whether a touch event occurs, when the first resistor line part and the second resistor part contact each other by an external pressure or force; detecting a current outputted from the first resistor line part when the first resistor line part and the second resistor part contact each other, in a case where the touch event is determined as occurring; comparing a level of the detected current with a level of a predetermined reference current; calculating coordinate information of a single-touched first point on the basis of the detected voltage, when the level of the detected current is lower than or equal to the level of the predetermined reference current; and

calculating coordinate information of multi-touched second and third points on the basis of the detected voltage and the detected current, when the level of the measured current is higher than the level of the predetermined reference current.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a touch screen according to an embodiment of the inventive concept;

FIG. 2 is an exploded perspective view illustrating a touch panel of FIG. 1;

FIG. 3A is a plan view illustrating a first resistor line part of FIG. 2;

FIG. 3B is a plan view illustrating a second resistor part of FIG. 2;

FIG. 4 is a flowchart illustrating an operation of the touch screen of FIG. 1;

FIG. 5 is a circuit diagram schematically illustrating an equivalent circuit of a first resistor line part when single touch occurs in the touch panel of FIG. 2;

FIG. 6 is a circuit diagram schematically illustrating an equivalent circuit of a first resistor line part and a second resistor part when multi-touch occurs in the touch panel of FIG. 2;

FIG. 7 is a view for describing a method of calculating coordinate information of one touch point when single touch occurs in the touch panel of FIG. 2;

FIG. 8 is a graph for describing a method of calculating coordinate information of two touch points when multi-touch occurs in the touch panel of FIG. 2;

FIG. 9 is a graph for describing a method of calculating a distance between two touch points when multi-touch occurs in the touch panel of FIG. 2;

FIG. 10 is an enlarged plan view of one surface of a first substrate in a touch panel included in a touch screen according to another embodiment of the inventive concept;

FIG. 11 is a block diagram illustrating a touch screen according to another embodiment of the inventive concept;

FIG. 12 is an exploded perspective view illustrating a touch panel and sub touch panel of FIG. 11;

FIG. 13A is a plan view illustrating a first sub resistor part of FIG. 12;

FIG. 13B is a plan view illustrating a second sub resistor part of FIG. 12;

FIG. 14A is an equivalent circuit diagram of the first sub resistor part when single touch occurs in a touch panel of FIG. 13; and

FIG. 14B is an equivalent circuit diagram of the second sub resistor part when single touch occurs in the touch panel of FIG. 13.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Thus, it is intended that the present invention covers the modifications and variations of this invention provided they come within the scope of the appended claims and their equivalents.

Like reference numerals refer to like elements throughout. In the accompanying drawings, the dimensions of respective structures may be exaggerated for clarity of illustration. Terms like a first and a second may be used to describe various elements, but the elements should not be limited by the terms. The terms may be used only as object for distinguishing an element from another element. For example, without departing from the spirit and scope of the inventive concept, a first element may be referred to as a second element, and similarly, the second element may be referred to as the first element.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. Moreover, it will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present.

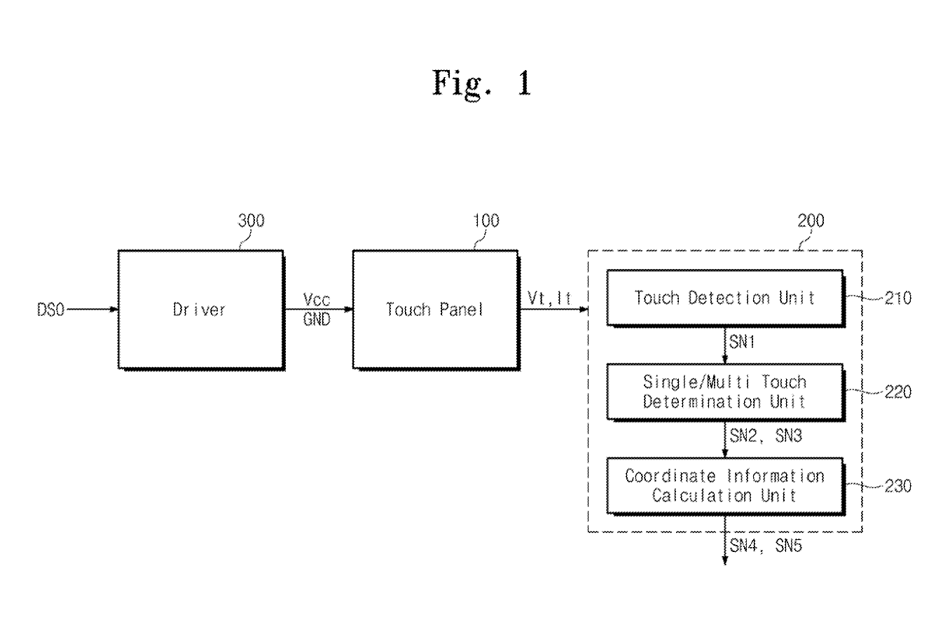

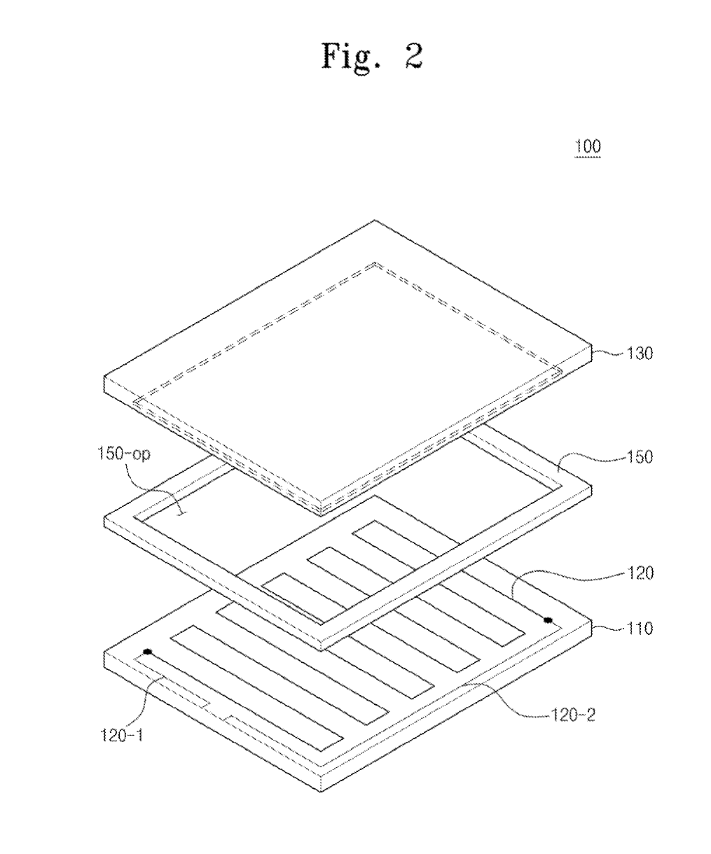

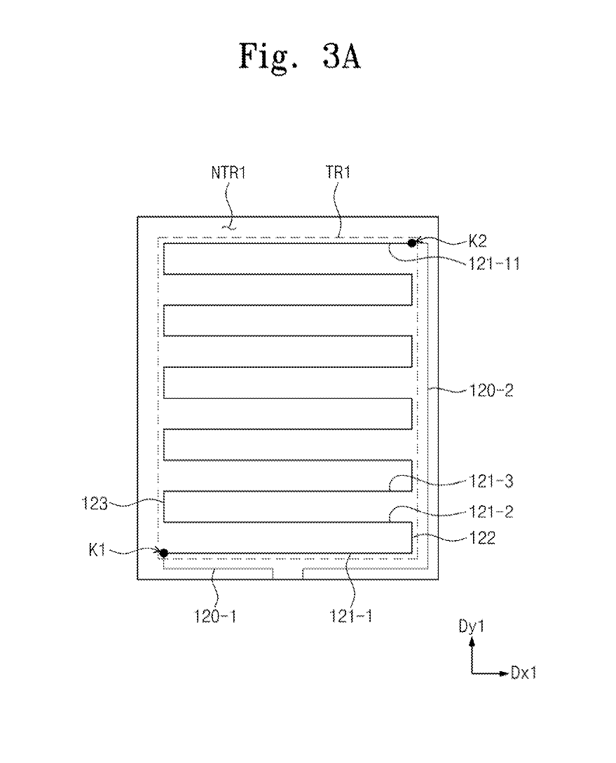

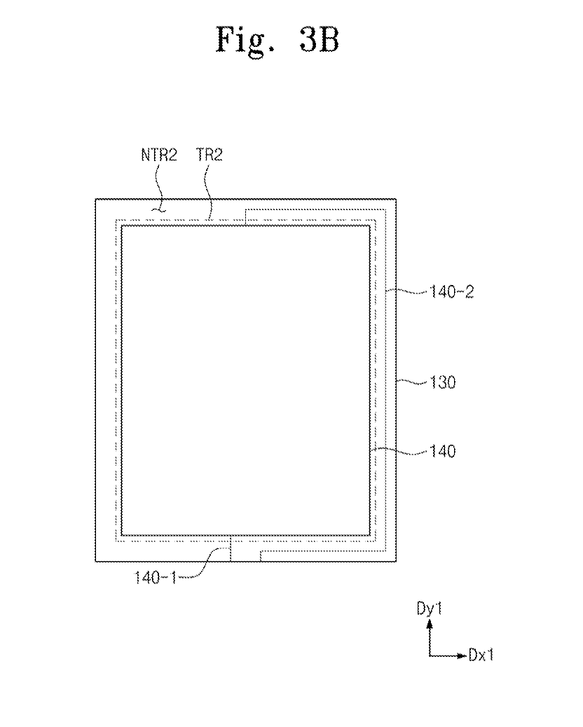

FIG. 1 is a block diagram illustrating a touch screen system according to an embodiment of the inventive concept. FIG. 2 is an exploded perspective view illustrating a touch panel of FIG. 1. FIG. 3A is a plan view illustrating a first resistor line part of FIG. 2. FIG. 3B is a plan view illustrating a second resistor part of FIG. 2.

A touch screen system according to an embodiment of the inventive concept, as illustrated in FIG. 1, includes a touch panel 100 providing a touch surface that allows specific information to be selected according to a user's selection, and a driver 300 supplying a first voltage Vcc and a second voltage GND to the touch panel 100 according to an input signal DSO. Also, the touch screen system includes a coordinate processor 200 determining whether a touch event is single touch or multi-touch to calculate coordinate information of a touched point when the touch event occurs in the touch panel 100.

More specifically, the coordinate processor 200 includes a touch detection unit 210 detecting whether the user touches the touch surface, a single/multi touch determination unit 220 determining whether the touch of the touch surface is single touch or multi-touch, and a coordinate information calculation unit 230 calculating coordinate information of a touched point.

First, a detailed description on the touch panel 100 will be made below with reference to FIGS. 2, 3A and 3B. The touch panel 100 includes first and second substrates 110 and 130 facing each other.

A glass substrate, a film substrate or a fiber substrate may be used as the first and second substrates 110 and 130. Among the substrates, the film substrate may be formed of poly ethylen terephthalate (PET), polymethyl methacrylate (PMMA), polypropylene (PP), polypropylene (PE), polycarbonate (PC), poly ether sulfone (PES), polyimide (PI), polyvinyl alcohol (PVA), cyclic olefin copolymer (COC), or the like, but is not limited thereto.

Herein, the second substrate 130 may use a flexible film substrate. In a case where the film substrate is used as the second substrate, a first resistor line part 120 and a second resistor part 140 may easily contact each other when a touch event occurs.

Moreover, the first substrate 110 includes a first touch region TR1 providing a substantial touch surface, and a first non-touch region NTR1 surrounding the first touch region TR1. The second substrate 130 includes a second touch region TR2 providing a substantial touch surface, and a second non-touch region NTR2 surrounding the second touch region TR2. Generally, the touch screen system is disposed in the front of a display device, and the user inputs information by touching an icon, displayed on the display device, with the touch screen. Herein, the first and second touch regions TR1 and TR2 of the touch screen are defined as regions through which images generated by the display device pass. The shapes and areas of the first and second touch regions TR1 and TR2 may correspond to each other, and the shapes and areas of the first and second non-touch regions NTR1 and NTR2 may correspond to each other.

The touch panel 100 includes the first resistor line part 120 located in one surface of the first substrate 110, and the second resistor part 140 located in one surface of the second substrate 130 facing the first resistor line part 120. Herein, the first resistor line part 120 is located inside the first touch region TR1 defined in one surface of the first substrate 110.

The first resistor line part 120 is bent several times. That is, the first resistor line part 120 may have a zigzag shape where one line resistor is not overlapped. In this case, the first voltage Vcc is applied to a first end K1 of the first resistor line part 120, and the second voltage GND having a potential lower than the first voltage Vcc is applied to a second end K2 of the first resistor line part 120. Hereinafter, in this embodiment, the second voltage GND will be exemplarily described as being a ground voltage.

Particularly, the first resistor line part 120 may have a shape illustrated in FIG. 3A. To provide a more detailed description, the first resistor line part 120 includes p number of first resistor lines 121-1 to 121-11 (where p is a natural number equal to or more than two, but p is eleven in FIG. 3A) that are extended in a first direction Dx1 and arranged to be spaced apart from each other in a second direction Dy1 vertical to the first direction Dx1, on the first touch region TR1. Each of the first resistor lines 121-1 to 121-11 includes first and second end portions.

The first resistor line part 120 includes a second resistor line 122 that connects a first end portion of an nth first resistor line and a first end portion of an n+1st first resistor line (where n is an odd number equal to or less than p−1) among the p first resistor lines 121-1 to 121-11, and a third resistor line 123 that connects a second end portion of the n+1st first resistor line and a second end portion of the n+2nd first resistor line among the p first resistor lines 121-1 to 121-11.

For example, as illustrated in FIG. 3, when the first resistor line part 120 includes eleven first resistor lines, a first end portion of the 1st first resistor line 121-1 and a first end portion of the 2nd first resistor line 121-2 are connected by the second resistor line 122. Also, a second end portion extended from the first end portion of the 2nd first resistor line 121-2 and a second end portion of the 3rd first resistor line 121-3 are connected by the second resistor line 122.

The first resistor line part may have a constant line resistance per unit length. In FIG. 3A, the first resistor lines 121-1 to 121-11, the second resistor line 122, and the third resistor line 123 are illustrated as lines, but may have a certain width (which is a length in the first direction). Herein, the widths of the first to third resistor lines 121 to 123 may be equal, and moreover, the thicknesses of the first to third resistor lines 121 to 123 may be equal.

To equalize intervals between adjacent first resistor lines among the eleven first resistor lines 121-1 to 121-11, the lengths of the second and third resistor lines 122 and 123 may be the same.

The second resistor part 140 having a thin film shape is located in the second touch region TR2, and the first resistor line part 120 and the resistor part 140 face each other. As illustrated in FIG. 3B, the second resistor part 140 having the thin film shape may be disposed over the second touch region TR2.

The first resistor line part 120 and the resistor part 140 may be formed of a transparent conductive material. For example, the transparent conductive material a metal oxide such as indium tin oxide (ITO), or a conductive polymer such as poly thiophene, poly pyrrole, poly aniline, poly acetylene, or poly phenylene.

The touch panel 100, as illustrated in FIG. 2, may further include a spacer 150. The spacer 150 separates the first and second substrates 110 and 130 by a certain interval, and couples the first and second substrates 110 and 130. The spacer 150, as illustrated in FIG. 2, may have a closed-loop shape including an opening 150-op therein. In this case, the opening 150-op may have a size corresponding to the touch regions TR1 and TR2. Therefore, the spacer 150 is disposed between the first and second substrates 120 and 130 and in the non-touch regions NTR1 and NTR2.

The touch panel 100 may further include first and second lines 120-1 and 120-2 located in the first non-touch region NTR1. The first line 120-1 is connected to the first end K1 of the first resistor line part 120 to supply the first voltage Vcc, and the second line 120-2 is connected to the second end K2 of the first resistor line part 120 to supply the second voltage GND.

The second substrate 130 may further include a detection line located in the second non-touch region NTR2. The detection line supplies a voltage Vt (see FIG. 1), outputted to the second resistor part 140, to the coordinate processor 200. The detection line may include a third line 140-1 connected to the second resistor part 140. The third line 140-1 may be connected to a first side 140-a of the second resistor part 140.

Moreover, the detection line may further include a fourth line 140-2 located in the second non-touch region NTR2. The fourth line 140-2 is connected to a second side 140-b of the second resistor part 140 facing the first side 140-a of the second resistor part 140.

When the detection line includes the third and fourth lines 140-1 and 140-2, the voltage Vt outputted from the second resistor part 140 is alternately supplied to the coordinate processor 200 through the third and fourth lines 140-1 and 140-2. The coordinate processor 200 may calculate coordinate information of a touched point on the basis of an average value of the voltages Vt detected through the respective third and fourth lines 140-1 and 140-2. Accordingly, the accuracy of the coordinate information is enhanced. A detailed description on this will be made below.

The first to fourth lines 120-1, 120-2, 140-1 and 140-2 may be formed of a metal material such as copper (Cu). Also, a microprocessor may be applied as the coordinate processor 200, and each of the first to fourth lines 120-1, 120-2, 140-1 and 140-2 may be connected to the microprocessor through a Flexible Printed Circuit Board (FPCB) adhered to the first and second substrates 110 and 130.

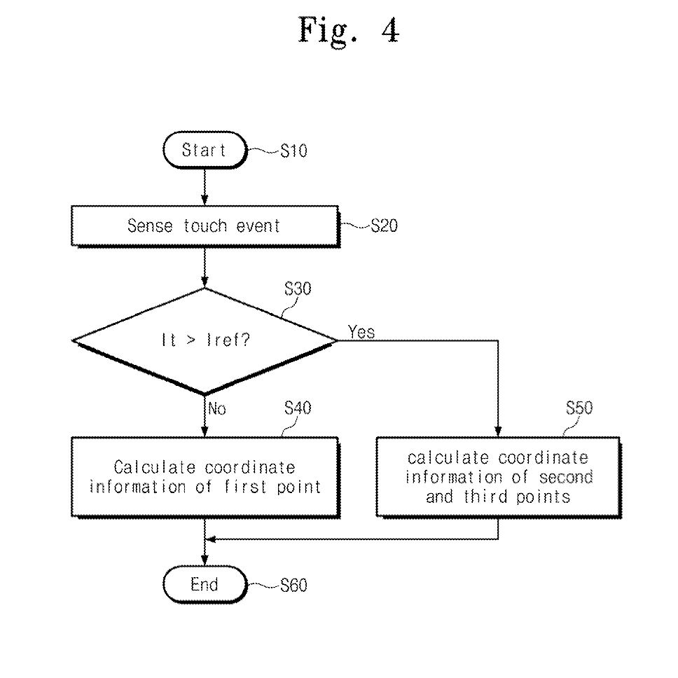

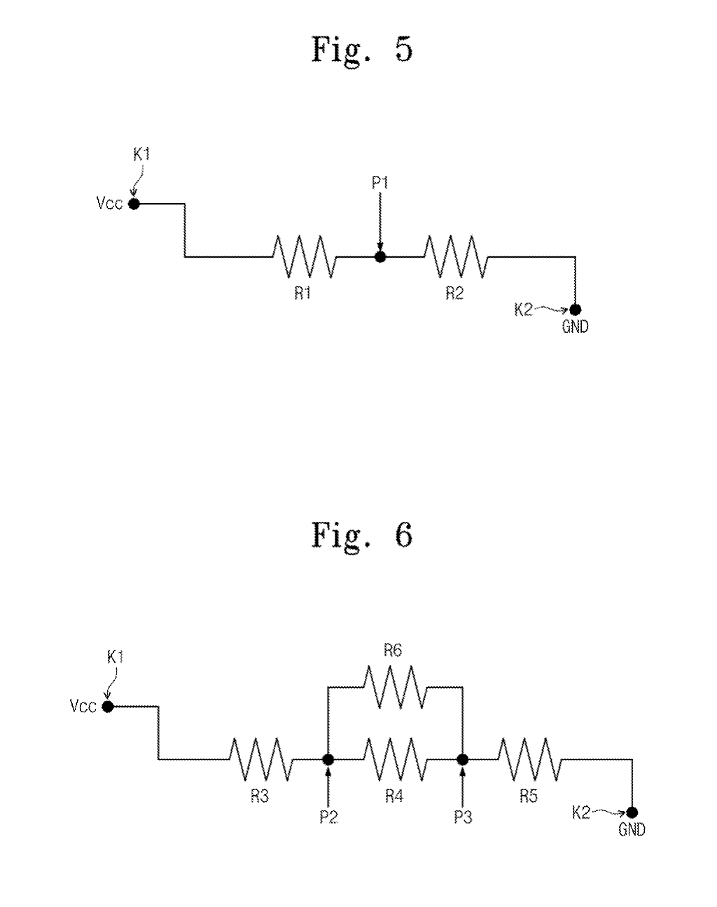

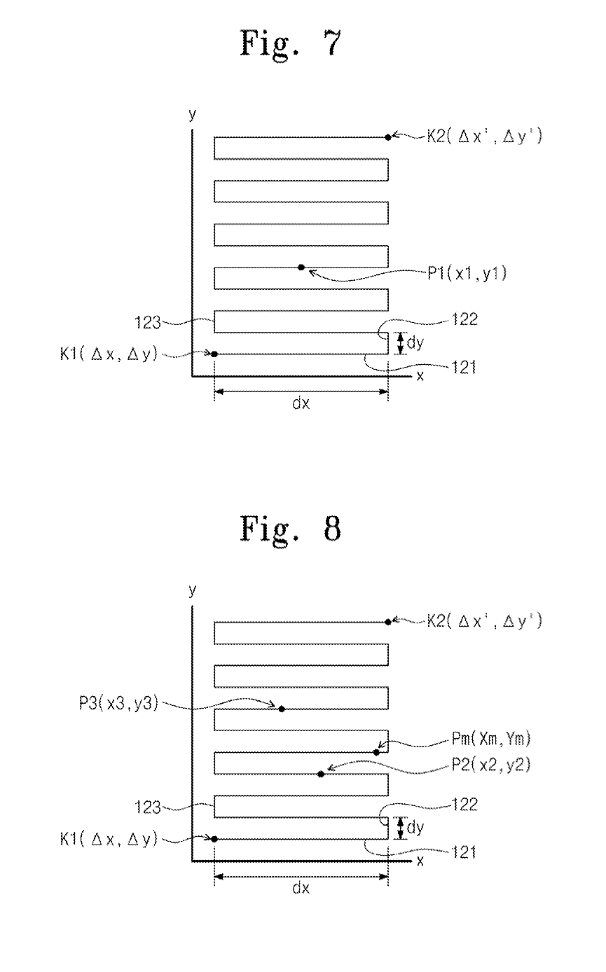

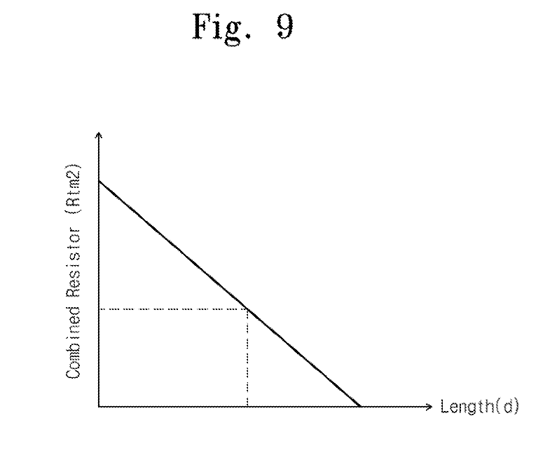

FIG. 4 is a flowchart illustrating an operation of the touch screen system of FIG. 1. FIG. 5 is a circuit diagram schematically illustrating an equivalent circuit of the first resistor line part when single touch occurs in the touch panel of FIG. 2. FIG. 6 is a circuit diagram schematically illustrating an equivalent circuit of the first resistor line part and second resistor part when multi-touch occurs in the touch panel of FIG. 2. FIG. 7 is a view for describing a method of calculating coordinate information of one touch point when single touch occurs in the touch panel of FIG. 2. FIG. 8 is a graph for describing a method of calculating coordinate information of two touch points when multi-touch occurs in the touch panel of FIG. 2. FIG. 9 is a graph for describing a method of calculating a distance between two touch points when multi-touch occurs in the touch panel of FIG. 2. Hereinafter, an operation of the touch screen system and a method of calculating a touch point of the touch screen system will be described in detail with reference to FIGS. 4 to 9.

When an image is displayed on the display device (not shown), an input signal DSO is applied to the driver 300. The driver 300 receives the input signal DSO (see FIG. 1) to apply the first and second voltages Vcc and GND (see FIG. 1) to the touch panel 100. The first voltage Vcc is applied to the first end K1 of the first resistor line part 120 (see FIGS. 1 to 3B), and the second voltage GND having a potential lower than the first voltage Vcc is applied to the second end K2. This corresponds to a stage where an operation of the touch screen is started as illustrated in FIG. 4 in operation S10. The first and second voltages Vcc and GND may be supplied to the touch panel 100 at certain time intervals.

When first and second voltages Vcc and GND are supplied to the first resistor line part 120, as illustrated in FIG. 4, a touch event occurring in the touch panel 100 (see FIGS. 1 to 3B) is sensed in operation S20. The touch detection unit 210 determines the occurrence of the touch event according to whether the voltage Vt is detected from the second resistor part 140.

Specifically, when the touch panel 100 is touched, a voltage is outputted to the second resistor part 140, but when the touch panel 100 is not touched, a voltage is not outputted to the second resistor part 140. When the second substrate 130 is bent by an external force/pressure, the second resistor part 140 and the first resistor line part 120 contact each other. At this point, the touch detection unit 210 measures a potential of the second resistor part 140 to detect the voltage Vt.

Therefore, when the voltage Vt is detected, the touch detection unit 210 determines the occurrence of the touch event, but when the voltage Vt is not detected, the touch detection unit 210 determines that the touch event does not occur.

When the third and fourth lines 140-1 and 140-2 are located in the second non-touch region NTR2, the touch detection unit 210 may detect the voltage Vt with the third and fourth lines 140-1 and 140-2.

When the touch event is determined as occurring, as illustrated in FIG. 4, the touch detection unit 210 measures a current It outputted to the first resistor line part 120, and compares the level of the current It with the level of a predetermined current Iref in operation S30.

For example, when a voltage is detected, the touch detection unit 210 outputs a first signal SN1 (see FIG. 1) to the single/multi touch determination unit 220. The single/multi touch determination unit 220 receiving the first signal SN1 measures a current of the first resistor line part 120. Subsequently, the single/multi touch determination unit 220 compares the level of the measured current It with the level of the predetermined current Iref.

The first signal SN1 may include information that indicates the level of a voltage outputted to the second resistor part 140, and be outputted as a digital signal through an analog-to-digital converter. Also, when the third and fourth lines 140-1 and 140-2 are located in the second non-touch region NTR2, the first signal SN1 may include information that indicates the average level of the voltage Vt detected through the third and fourth lines 140-1 and 140-2.

The single/multi touch determination unit 220 determines touch as single touch when the level of the measured current It is less than or equal to that of the predetermined current Iref, but determines touch as multi-touch when the level of the measured current It is higher than that of the predetermined current Iref.

When the first and second voltages Vcc and GND are applied to the first and second ends K1 and K2 of the first resistor line part 120 having a certain line resistance per unit length, as the length of the first resistor line part 120 increases, a constant voltage is dropped from the first end K1 to the second end K2. When the first resistor line part 120 and the second resistor part 140 do not contact each other, a current flowing in the first resistor line part 120 due to the first and second voltages Vcc and GND is detected from the first resistor line part 120. When the first resistor line part 120 and the second resistor part 140 do not contact each other, the level of the predetermined current Iref is the same as that of a current detected from the first resistor line part 120.

When single touch occurs in the touch panel 100, as illustrated in FIG. 5, the first resistor line part 120 is divided into first and second resistors R1 and R2 with respect to a first point P1. The first and second resistors R1 and R2 are connected in series, and thus, the combined resistor Rtm1 of the resistors has the same resistance value as a resistance value Rref of the first resistor line part 120 before touch occurs. Therefore, even when single touch occurs, the level of the current It (see FIG. 1) detected from the first resistor line part 120 is the same as that of the predetermined current Iref. The first and second voltages Vcc and GND are discharged depending on the case, and thus, the level of the current It (see FIG. 1) detected from the first resistor line part 120 may be lower than that of the predetermined current Iref.

When multi-touch occurs in the touch panel 100, namely, when touch occurs in second and third points P2 and P3, as illustrated in FIG. 6, the first resistor line part 120 is divided into third to fifth resistors R3 to R5.

Among the third to fifth resistors R3 to R5, the third resistor R3 is a resistor between the first end K1 of the first resistor line part 120 and the second point P2, and the fifth resistor R5 is a resistor between the second end K2 of the first resistor line part 120 and the third point P3. The fourth resistor R4 is a resistor between the second third points P2 and P3.

A sixth resistor R6 is connected to the fourth resistor R4 in parallel between the second and third points P2 and P3 of the second resistor part 140. The sixth resistor R6 is a resistor that is formed in the second resistor part 140 having a low resistance value, and thus has a resistance value far lower than the fourth resistor R4 formed in the first resistor line part 120. Herein, a combined resistor of the fourth and sixth resistors R4 and R6 connected in parallel has a resistance value far lower than a combined resistor of the third and fifth resistors R3 and R5, and thus is ignored by a combined resistor Rtm2 of the first resistor line part 120 when the multi-touch occurs. That is, when the multi-touch occurs, the combined resistor Rtm2 of the first resistor line part 120 has the same resistance value as that of a combined resistor which is formed by serially connecting the third and fifth resistors R3 and R5. As a result, when the multi-touch occurs, the level of the current It detected from the first resistor line part 120 is higher than that of the predetermined current Iref.

When single touch is determined as the compared result of the levels of the detected current It and predetermined current Iref, the single/multi touch determination unit 220 calculates coordinate information of the first point P1 in operation S40, or when multi-touch is determined, the single/multi touch determination unit 220 calculates coordinate information of the second and third points P2 and P3 in operation S50.

For example, when the touch event is determined as the single touch, the single/multi touch determination unit 220 may output a second signal SN2 (see FIG. 1), or when the touch event is determined as the multi-touch, the single/multi touch determination unit 220 may output a third signal SN3 (see FIG. 1). Herein, the second signal SN2 may include information indicating that the touch event is single touch, and information indicating the level of the detected voltage Vt or information indicating the average level of the voltage detected through the third and fourth lines 140-1 and 140-2. Also, the third signal SN3 may include information indicating that the touch event is multi-touch, information indicating the level of the detected voltage Vt, and information indicating the level of the detected current It.

The coordinate information calculation unit 230 receives the first and second signals SN2 and SN3 to calculate coordinate information of the first point P1 or coordinate information of the second and third points P2 and P3.

The following description will be made in detail with reference to FIG. 7 on a method that calculates the coordinate information of the first point P1 when touch is determined as the single touch. The touch detection unit 210 recognizes the detected voltage Vt as a voltage of the first point P1, and thus, the coordinate information calculation unit 230 calculates the coordinate information of the first point P1.

As illustrated in FIG. 7, coordinate information of the first end K1 of the first resistor line part 120 is defined as K1 (Δx, Δy), and coordinate information of the second end K2 is defined as K2 (Δx′, Δy′). Also, the length of each of the first resistor lines 121 in the first direction Dx1 is defined as dx, and the length of each of the second and third resistor lines 122 and 123 in the second direction Dy1 is defined as dy. Each point of the first resistor line part 120 may correspond to a coordinate of a planar surface in one-to-one correspondence relationship from a line-surface geometric relationship. Also, since the first resistor line part 120 has a conformal line resistance, a resistance from the first end K1 to the first point P1 increases in proportion to a length from the first end K1 to the first point P1. In other words, the level of a voltage outputted from the second resistor part 140 through the first point P1 is inversely proportional to the length of the first resistor line part 120 from the first end K1 to the first point P1.

The first voltage Vcc is applied to the first end K1, and the second voltage GND being the ground voltage is applied to the second end K2. Therefore, the ratio of the voltage Vt (which is outputted to the second resistor part 140 through the first point P1) and the first voltage Vcc is the same as the ratio of the length of the first resistor line part 120 from the second end K2 to the first point P1 and the entire length of the first resistor line part 120. That is, Equation (1) below is established.

Vcc:Vts=L:(L−L(x1, y1)) (1)

where Vts is a voltage that is outputted to the second resistor 140 through the first point P1 when touch is determined as single touch, L is the entire length of the first resistor line part 120, and L(x1, y1) is a length from the first end K1 to the first point (x1, y1).

Equation (2) is established by rearranging Equation (1) on L(x1, y1).

L(x1, y1)=L×(Vcc−Vts)/Vcc (2)

where y coordinate information of the first point P1 is obtained when an integer value is calculated by dividing L(x1, y1) by (dx+dy).

The y coordinate information may be obtained with Equations (3) and (4) below.

N=int{L(x1, y1)/(dx+dy)} (3)

y1=N×dy+Δy (4)

The x coordinate information (x1) of the first point P1 is calculated by using the y coordinate information (y1) of the first point P1 and Equations (5) to (7) below.

M=L(x1, y1) −N×(dx+dy) (5)

x1=M+Δx, when N is an even number (6)

x1=dx=M+Δx, when N is an odd number (7)

In this way, when coordinate information (P1(x1, y1)) of the first point P1 is calculated, the coordinate information calculation unit 230 provides the coordinate information (P1(x1, y1)) of the first point P1 to the display device. That is, the coordinate information calculation unit 230 outputs a fourth signal SN4 (see FIG. 1) including the coordinate information (P1(x1, y1)) of the first point P1. The display device receives the fourth signal SN4 to convert an image so as to display information indicated by the first point P1.

In calculating the coordinate information of the first point P1 with Equations (1) to (7), Vts in Equations (1) and (2) is an average value that is detected with the third and fourth lines 140-1 and 140-2.

The following description will be made in detail with reference to FIG. 8 on a method that calculates the coordinate information of the second and third points P2 and P3 when touch is determined as the multi-touch. The coordinate information calculation unit 230 calculates the coordinate information of the second and third points P2 and P3 on the basis of the voltage Vt detected by the touch detection unit 210 and the current It detected by the single/multi touch determination unit 220.

As illustrated in FIG. 8, when touches occur in the second and third points P2 and P3, the combined resistor Rtm2 between the first and second ends K1 and K2 of the first resistor line part 120 is substantially equal to that the third fifth resistors R3 and R5 are serially connected.

When touches occur in the second and third points P2 and P3, the coordinate information calculation unit 230 recognizes the voltage Vt, detected by the touch detection unit 210, as a virtual voltage of a center point Pm between the second and third points P2 and P3 in the first resistor line part 120. That is, when single touch occurs in the center point Pm, the coordinate information calculation unit 230 recognizes the voltage Vt, detected by the touch detection unit 210, as a voltage detected by the touch detection unit 210.

The coordinate information calculation unit 230 calculates a length d between the second and third points P2 and P3 in the first resistor line part 120. As illustrated in FIG. 9, as the length d between the second and third points P2 and P3 becomes greater, the combined resistor Rtm2 between the first and second ends K1 and K2 of the first resistor line part 120 is reduced. That is, the length d between the second and third points P2 and P3 is inversely proportional to the combined resistor Rtm2 between the first and second ends K1 and K2 of the first resistor line part 120.

A specific resistance value between the first and second ends K1 and K2 of the first resistor line part 120 and a potential difference between the first voltage Vcc and the second voltage GND are constant, and thus, the length of the first resistor line part 120 between the second and third points P2 and P3 may be calculated by measuring the value of the current It outputted to the first resistor line part 120. The length is calculated with Equations (8) and (9) below.

Iref:It2=Vcc/Rref:Vcc/Rtm2 (8)

Rref:Rtm2=L:(L−d) (9)

where Iref is a predetermined current, and It2 is a current value that is detected from the first resistor line part 120 when touches occur in the second and third points P2 and P3. Rref is a specific resistance value of the first resistor line part 120, and Rtm2 is a combined resistor of the first resistor line part 120 when touches occur in the second and third points P2 and P3. L is the entire length of the first resistor line part 120, and d is the length of the first resistor line part 120 between the second and third points P2 and P3 when multi-touch occurs.

When the length d of the first resistor line part 120 between the second and third points P2 and P3 is calculated, the coordinate information calculation unit 230 calculates virtual voltages of the second and third points P2 and P3. The virtual voltage of the second point P2 is the same as a voltage that is detected by the touch detection unit 210 when single touch occurs in the second point P2, and the virtual voltage of the third point P3 is the same as a voltage that is detected by the touch detection unit 210 when single touch occurs in the third point P3.

A virtual voltage Vp2 of the second point P2 is calculated with Equation (10) below, and a virtual voltage Vp3 of the third point P3 is calculated with Equation (11) below.

Vp2=Vtm−Vcc×(d/2)×(1/L) (10)

Vp3=Vtm+Vcc×(d/2)×(1/L) (11)

where Vtm is a voltage value that is detected by the touch detection unit 210 when the touch event is determined as multi-touch.

The coordinate information calculation unit 230 calculates the coordinate information (P2(x2, y2)) of the second point P2 by computing the virtual voltage Vp2 of the second point P2 according to Equations (1) to (7). Also, the coordinate information calculation unit 230 calculates the coordinate information (P3(x3, y3)) of the third point P3 by computing the virtual voltage Vp3 of the third point P3 according to Equations (1) to (7).

The coordinate information calculation unit 230 outputs a fifth signal SN5 including the coordinate information (P2(x2, y2)) of the second point P2 and the coordinate information (P3(x3, y3)) of the third point P3, in the same scheme as a scheme where the coordinate information (P1(x1, y1)) of the first point P1 has been calculated. The display device receives the fifth signal SN5 to convert an image so as to display information indicated by the second and third points P2 and P3.

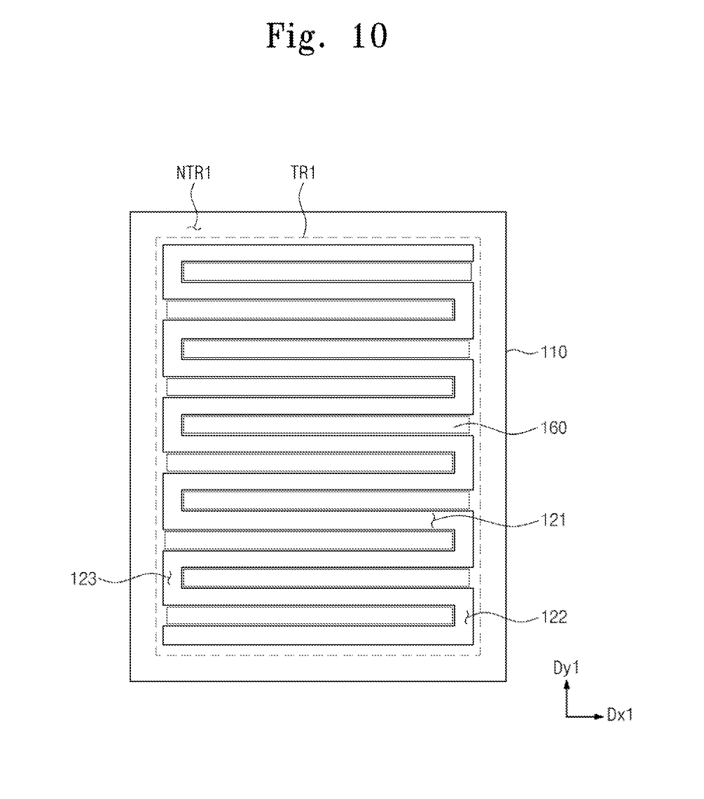

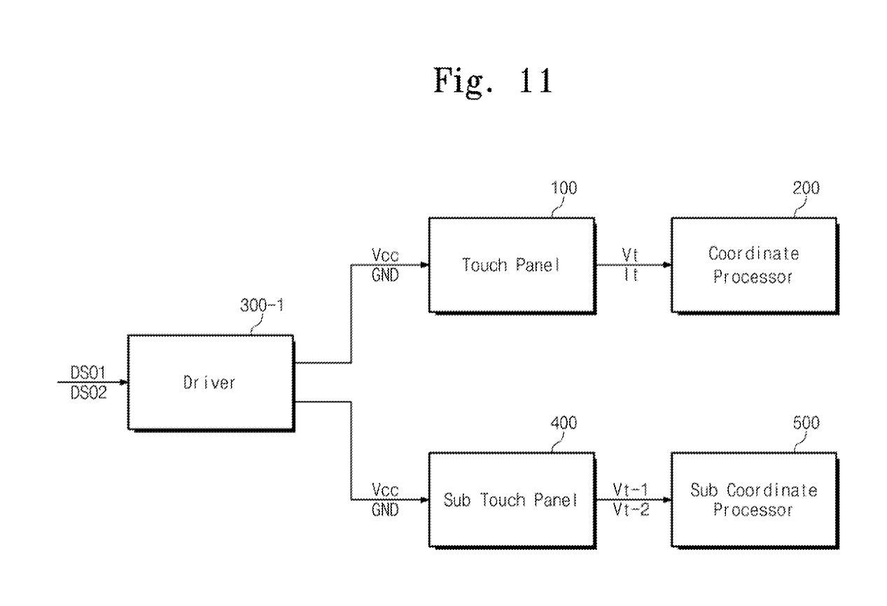

FIG. 10 is an enlarged plan view of one surface of a first substrate in a touch panel included in a touch screen system according to another embodiment of the inventive concept. Hereinafter, a touch screen system according to another embodiment of the inventive concept will be described with reference to FIG. 10. However, a description that is repetitive of the above-described of FIGS. 1 to 9 will not be provided.

A touch panel 100 (see FIG. 1) according to another embodiment of the inventive concept includes a first resistor line part 120 illustrated in FIG. 3A. As described above with reference to FIG. 3A, the first resistor line part 120 includes a plurality of first resistor lines 121 that are extended in the first direction Dx1 and arranged to be spaced apart from each other in the second direction Dy1 vertical to the first direction Dx1.

As described above, the touch panel 100 is attached to the display device (not shown) and operates. An image generated in the display panel passes through the first touch region TR1. Since the first resistor line part 120 is located only in a portion of the first touch region TR1, a refractive index difference occurs between a portion of the image passing though the first resistor line part 120 and another portion of the image that does not pass through the first resistor line part 120 in the image passing through the first touch region TR1, and thus, the uniformity of the image is reduced.

To solve such limitations, the touch panel 100 may further include a dummy pattern 160 that is located between two adjacent first resistor lines 121 among the p first resistor lines and extended in the first direction. The dummy pattern 160 compensates for the refractive index of an image passing through a region where the first resistor line part 120 is not formed so as to correspond to the refractive index of an image passing through the first resistor line part 120. Herein, the dummy pattern 160 is electrically insulated from the first resistor line part 120.

The dummy pattern 160 is formed of a transparent conductive material. Herein, a material forming the dummy pattern 160 may have the same refractive index as that of a material forming the first resistor line part 120. For this, the dummy pattern 160 may be formed of the same material as that of the first resistor line part 120 or second resistor part 140.

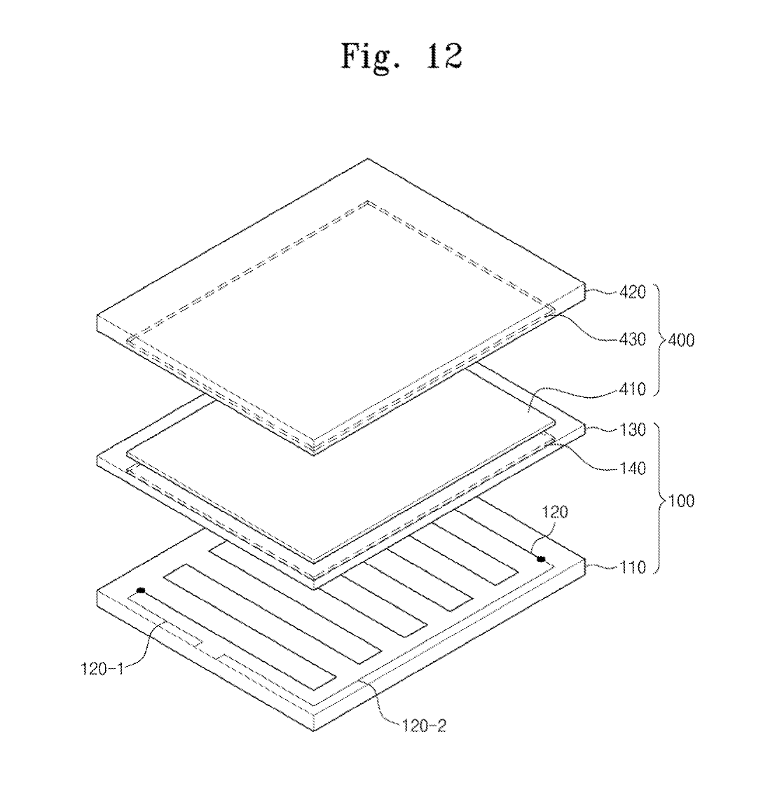

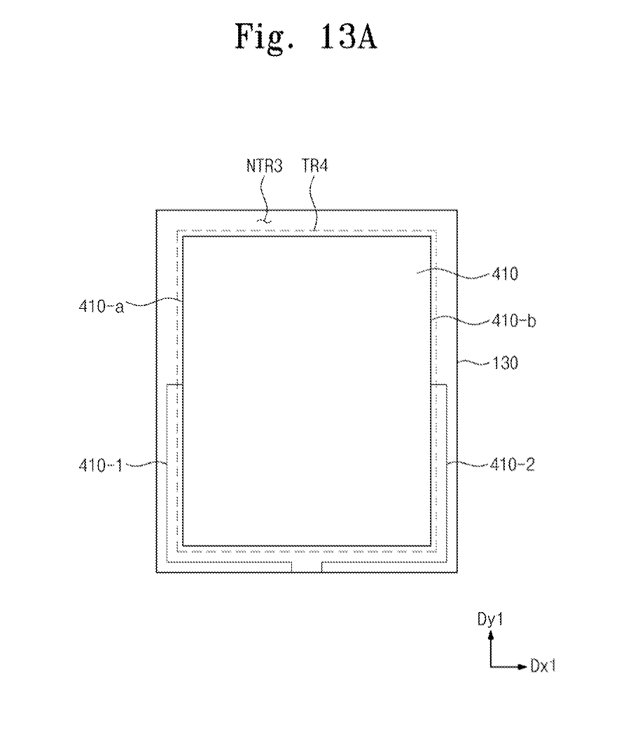

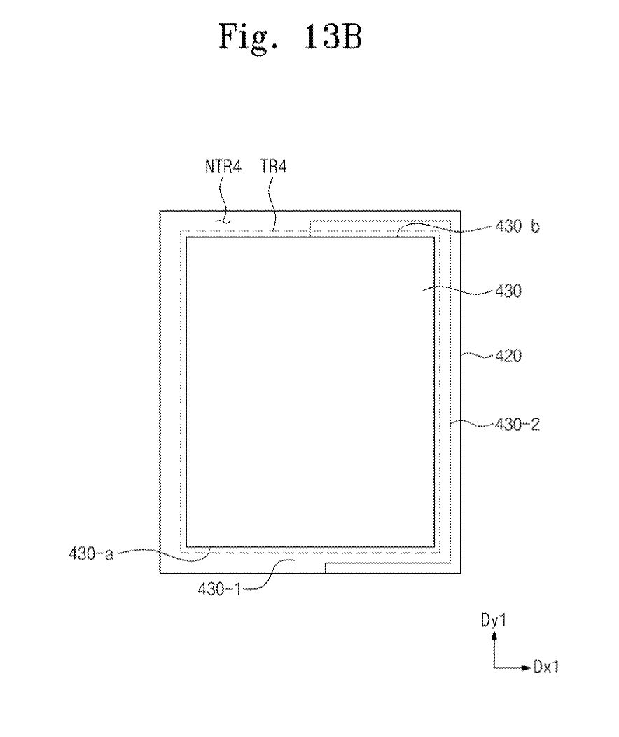

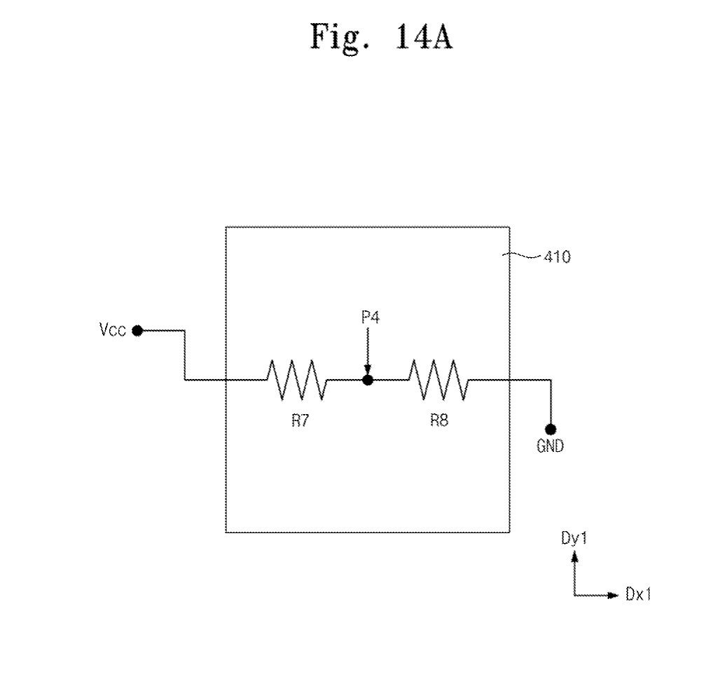

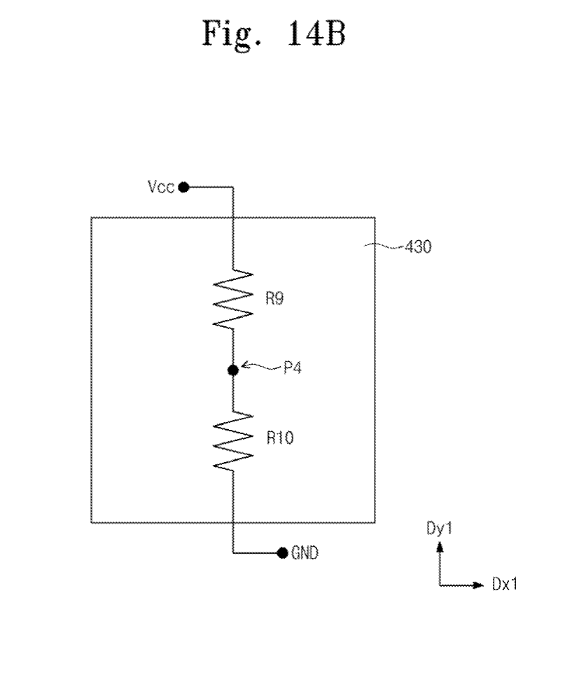

FIG. 11 is a block diagram illustrating a touch screen system according to another embodiment of the inventive concept. FIG. 12 is an exploded perspective view illustrating a touch panel and sub touch panel of FIG. 11. FIG. 13A is a plan view illustrating a first sub resistor part of FIG. 12. FIG. 13B is a plan view illustrating a second sub resistor part of FIG. 12. FIG. 14A is an equivalent circuit diagram of the first sub resistor part when single touch occurs in a touch panel of FIG. 13. FIG. 14B is an equivalent circuit diagram of the second sub resistor part when single touch occurs in the touch panel of FIG. 13. Hereinafter, the touch screen system according to another embodiment of the inventive concept will be described in detail with reference to FIGS. 11 to 14A. However, a detailed description on the same elements as those of FIGS. 1 to 10 will not be provided.

The touch screen system according to another embodiment of the inventive concept, as illustrated in FIGS. 11 and 12, may further include a sub touch panel 400 located in an upper side of the touch panel 100. The touch panel 100 and the sub touch panel 400 may independently operate to sense a touch event.

When a first input signal DSO1 is applied to a driver 300-1, the driver 300-1 applies the first and second voltages Vcc and GND to the touch panel 100. On the other hand, when a second input signal DSO2 is applied to the driver 300-1, the driver 300-1 applies the first and second voltages Vcc and GND to the sub touch panel 400. Therefore, the driver 300-1 drives one of the touch panel 100 and sub touch panel 400 according to the first and second input signals DSO1 and DSO2.

Hereinafter, the structure of the sub touch panel 400 and a method of calculating a coordinate will be described in detail. The sub touch panel 400, as illustrated in FIGS. 12 to 13B, includes a first sub resistor part 140 that is located in the other surface of a second substrate 130 included in the touch panel 100, a third substrate 420 that is disposed on the second substrate 130 and faces the second substrate 130, and a second sub resistor part 430 that is located in one surface of the third substrate 420 and faces the first sub resistor part 410.

The third substrate 420 may be formed of a flexible film substrate like the second substrate 130. The first and second sub resistor parts 410 and 430 may be formed of a material forming the second resistor part 140.

The other surface of the second substrate 130 includes a third touch region TR3 corresponding to the second touch region TR2, and a third non-touch region NTR3 corresponding to the second non-touch region NTR2. One surface of the third substrate 420 includes a fourth touch region TR4 corresponding to the third touch region TR3, and a fourth non-touch region NTR4 corresponding to the third non-touch region NTR3. Herein, the first sub resistor part 410 as a conductive thin film is disposed over the third touch region TR3, and the second sub resistor part 430 as a conductive thin film is disposed over the fourth touch region TR4. Therefore, the sub touch panel 400 configures a resistive touch panel.

Moreover, the sub touch panel 400 may further include two first sub lines 410-1 and 410-2 that are located in the third non-touch region NTR3 and connected to the first sub resistor part 410. The two first sub lines 410-1 and 410-2 are connected to first and second sides 410-a and 410-b of the first sub resistor part 410, respectively. Herein, the first and second sides 410-a and 410-b face each other in the first direction Dx1 of the first sub resistor part 410.

The first and second voltages Vcc and GND are supplied to the first sub resistor part 410 through the two first sub lines 410-1 and 410-2, respectively. When a touch event occurs, a sub coordinate processor 500 detects a voltage Vt-1 (see FIG. 11) outputted from the second sub resistor part 430 to acquire coordinate information in the first direction Dx1 for a point where the touch event occurs.

Moreover, the sub touch panel 400 may further include two second sub lines 430-1 and 430-2 that are located in the fourth non-touch region NTR4 and connected to the second sub resistor part 430. The two second sub lines 430-1 and 430-2 are connected to first and second sides 430-a and 430-b of the second sub resistor part 430, respectively. Herein, the first and second sides 410-a and 410-b face each other in the second direction Dy1 of the second sub resistor part 430. The first direction Dx1 is substantially perpendicular to the second direction Dy1.

The first and second voltages Vcc and GND are supplied to the second sub resistor part 430 through the two second sub lines 430-1 and 430-2, respectively. When a touch event occurs, the sub coordinate processor 500 detects a voltage Vt-2 (see FIG. 11) outputted from the first sub resistor part 410 to acquire coordinate information in the second direction Dy1 for a point where the touch event occurs.

A method of calculating coordinate information of a point where a touch event occurs, by the sub coordinate processor 500, will be described below with reference to FIGS. 14A and 14B.

To acquire coordinate information of a point P4 (hereinafter referred to as a fourth point) where a touch event occurs in the sub touch panel 400, the first and second voltages Vcc and GND are alternately applied to the first and second sub resistor parts 410 and 430, or applied to one of the first and second sub resistor parts 410 and 430 at a certain period. In this embodiment, applying the first and second voltages Vcc and GND to the first and second sub resistor parts 410 and 430 at a certain period will be exemplarily described below.

When a touch event occurs in the fourth point P4, the voltage Vt-1 is outputted from the second sub resistor part 430. The sub coordinate processor 500 detects the voltage Vt-1 to determine whether a touch event occurs.

The sub coordinate processor 500 may calculate coordinate information of the fourth point P4 in the first direction Dx1 on the basis of the level of the detected voltage Vt-1. When touch occurs in the fourth point P4, as illustrated in FIG. 14A, a resistor between two points connected to the two first sub lines 410-1 and 410-2 and the first sub resistor part 410 is divided into two resistors R7 and R8. The voltage Vt-1 outputted to the second sub resistor part 430 is determined according to a coordinate of the fourth point P4 in the first direction Dx1. That is, the voltage Vt-1 is determined according to a rate between the two resistors R7 and R8.

When the voltage Vt-1 outputted through the second sub resistor part 430 is sensed in the sub coordinate processor 500, the first and second voltages Vcc and GND are applied to the second sub resistor part 430, and a voltage Vt-2 outputted through the first sub resistor part 410 is detected. As illustrated in FIG. 14B, the second sub resistor part 430 are divided into two resistors R9 and R10 in the second direction Dy1 perpendicular to the first direction Dx1 with respect to the fourth point P4. Coordinate information of the fourth point P4 in the second direction is determined according to a rate between the two resistors R9 and R10.]

When coordinate information (P4(x4, y4)) of the fourth point P4 is calculated, the sub coordinate processor 500 provides a signal including the coordinate information (P4(x4, y4)) of the fourth point P4 to a display device (not shown), which displays a new image.

As described above, the touch screen system according to the embodiments of the inventive concept may determine multi-touch, and calculate coordinate information regarding each of two points where multi-touch occurs.

Moreover, the touch screen system includes two lines for supplying the driving voltage to both ends of the first resistor line part. Accordingly, the touch screen system can decrease the area for forming the line, and thus be miniaturized.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A touch screen system comprising:
a touch panel comprising a first substrate, a second substrate spaced apart from and facing the first substrate, a first resistor line part provided on one surface of the first substrate, and a second resistor part provided on one surface of the second substrate to face the first resistor line part, wherein the first resistor line part is bent several times, has a first end receiving a first voltage, and has a second end receiving a second voltage having a potential different from a potential of the first voltage;
a touch detection unit operatively coupled to the touch panel and configured to detect a voltage outputted from the second resistor part to determine whether a touch event occurs, when the first resistor line part and the second resistor part contact each other by an external pressure or force;
a single/multi touch determination unit operatively coupled to the touch detection unit and configured to determine the touch event as single or multi touch by measuring a current in the first resistor line part and comparing a level of the measured current with a level of a predetermined reference current, when the touch event is determined as occurring, wherein the single/multi touch determination unit determines the touch event as single touch when the level of the measured current is lower than or equal to the level of the predetermined reference current, or determines the touch event as multi-touch when the level of the measured current is higher than the level of the predetermined reference current; and
a coordinate information calculating unit operatively coupled to the single/multi touch determination unit and configured to calculate and output coordinate information of a single-touched first point or one of coordinate information of multi-touched second and third points.

2. The touch screen system of claim 1, wherein the coordinate information calculation unit recognizes the voltage, outputted from the second resistor part, as a voltage of the first point to calculate the coordinate information of the first point, when the touch event is determined as the single touch event.

3. The touch screen system of claim 1, wherein the coordinate information calculation unit recognizes the voltage, outputted from the second resistor part, as a virtual voltage of a center point between the second and third points on the first resistor line part, when the touch event is determined as the multi-touch event.

4. The touch screen system of claim 3, wherein the coordinate information calculation unit receives a current outputted from the first resistor line part and calculates a distance between the second and third points on the first resistor line part on the basis of the received current, when the touch event is determined as the multi-touch event.

5. The touch screen system of claim 4, wherein the coordinate information calculation unit calculates a virtual voltage of the second point and a virtual voltage of the third point on the basis of the virtual voltage of the center point and the distance determined between the second and third points, and calculates the coordinate information of the second and third points on the basis of the virtual voltages of the second and third points.

6. The touch screen system of claim 1, wherein,
the one surface of the first substrate comprises a first touch region where the first resistor line part is formed, and a first non-touch region surrounding the first touch region,
the one surface of the second substrate comprises a second touch region corresponding to the first touch region of the first substrate, and a second non-touch region corresponding to the first non-touch region of the first substrate, and
the second resistor part is a conductive thin film disposed over the second touch region.

7. The touch screen system of claim 6, wherein the first resistor line part comprises:
A plural number p of first resistor lines (where p is a natural number equal to or more than two) extended in a first direction on the first touch region, and arranged to be spaced apart from each other in a second direction vertical to the first direction;
a second resistor line connecting a first end portion of an nth first resistor line (where n is an odd number equal to or less than p−1) and a first end portion of an n+1st first resistor line among the p first resistor lines; and
a third resistor line connecting a second end portion of the n+1st first resistor line and a second end portion of an n+2nd first resistor line among the p first resistor lines.

8. The touch screen system of claim 7, wherein the first substrate is provided between the nth first resistor line and the n+1st first resistor line, and further comprises a dummy pattern extended in the first direction.

9. The touch screen system of claim 8, wherein the dummy pattern is formed of a material having an approximately the same optical refractive index as a material forming the first resistor line part.

10. The touch screen system of claim 6, wherein the touch panel further comprises:
a first line provided in the first non-touch region, and supplying the first voltage to the first end of the first resistor line part; and
a second line provided in the first non-touch region, and supplying the second voltage to the second end of the first resistor line part.

11. The touch screen system of claim 10, wherein the touch panel further comprises a third line provided in the second non-touch region, and supplying the voltage, outputted from the second resistor part, to the touch detection unit.

12. The touch screen system of claim 11, wherein,
the third line is connected to a first side of the second resistor part, and
the touch panel comprises a fourth line connected to a second side of the second resistor part facing the first side and supplying the voltage, outputted from the second resistor part, to the touch detection unit.

13. The touch screen system of claim 1, further comprising:
a sub touch panel comprising a first sub resistor part provided on another surface differing from the one surface of the second substrate, a third substrate disposed on the second substrate to face the second substrate, and a second sub resistor part provided on one surface of the third substrate to face the first sub resistor part;
a sub coordinate processor configured to determine whether a touch event occurs in the sub touch panel, and to calculate coordinate information of a single-touched fourth point; and
a driver selectively driving the touch panel and the sub touch panel according to an input signal.

14. The touch screen system of claim 13, wherein,
the other surface of the second substrate comprises a third touch region corresponding to the second touch region, and a third non-touch region corresponding to the second non-touch region,
the one surface of the third substrate comprises a fourth touch region corresponding to the third touch region, and a fourth non-touch region corresponding to the third non-touch region,
the first sub resistor part includes a conductive thin film disposed over the third touch region, and
the second sub resistor part includes a conductive thin film disposed over the fourth touch region.

15. The touch screen system of claim 14, further comprising:
a first sub line provided in the third non-touch region, and connected to a first side of the first sub resistor part and a second side of the first sub resistor part facing the first side in a first direction; and
a second sub line provided in the fourth non-touch region, and connected to a first side of the second sub resistor part and a second side of the second sub resistor part facing the first side in a second direction perpendicular to the first direction.

16. A method of calculating a touch point of a touch screen which includes a first substrate, a second substrate facing the first substrate, a first resistor line part bent several times and provided on one surface of the first substrate, and a second resistor part provided on one surface of the second substrate and facing the first resistor line part, the method comprising:
applying a first voltage to a first end of the first resistor line part, and applying a second voltage having a potential different from a potential of the first voltage to a second end of the first resistor line part;
detecting a voltage outputted from the second resistor part to determine whether a touch event occurs, when the first resistor line part and the second resistor part contact each other by an external pressure or force;
detecting a current outputted from the first resistor line part when the first resistor line part and the second resistor part contact each other, in a case where the touch event is determined as occurring;
comparing a level of the detected current with a level of a predetermined reference current;
calculating coordinate information of a single-touched first point on the basis of the detected voltage, when the level of the detected current is lower than or equal to the level of the predetermined reference current; and
calculating coordinate information of multi-touched second and third points on the basis of the detected voltage and the detected current, when the level of the measured current is higher than the level of the predetermined reference current.

17. The method of claim 16, wherein the reference current has a level corresponding to a result value which is obtained by dividing a potential difference between the first and second voltages by total resistances of the first resistor line part.

18. The method of claim 17, wherein, in the calculating of coordinate information of multi-touched second and third points,
the detected voltage is recognized as a virtual voltage of a center point between the second and third points on the first resistor line part.

19. The method of claim 18, wherein the calculating of coordinate information of multi-touched second and third points comprises:
calculating a distance between the second and third points on the first resistor line part on the basis of the level of the detected current;
calculating virtual voltages of the second and third points on the basis of the distance between the second and third points, the virtual voltage of the center point, and a voltage drop rate across a length of the first resistor line part; and
converting the virtual voltage of the second point into the coordinate information of the second point, and converting the virtual voltage of the third point into the coordinate information of the third point.
